(19) United States
(12) Patent Application Publication
(10) Pub. No.: US 2024/0232716 A9
(43) Pub. Date: Jul. 11, 2024

(54) COMPUTER-READABLE RECORDING MEDIUM STORING MACHINE LEARNING SUPPORT PROGRAM, MACHINE LEARNING SUPPORT METHOD, AND INFORMATION PROCESSING APPARATUS

(71) Applicant: Fujitsu Limited, Kawasaki-shi (JP)

(72) Inventor: Takahiro FURUKI, Kawasaki (JP)

(73) Assignee: Fujitsu Limited, Kawasaki-shi (JP)

(21) Appl. No.: 18/485,340

(22) Filed: Oct. 12, 2023

(30) Foreign Application Priority Data
Oct. 21, 2022 (JP) 2022-168993

(51) Int. Cl. G06N 20/00

(52) U.S. Cl. CPC G06N 20/00

(57) ABSTRACT

A process includes receiving, by a machine learning support system, an instruction to generate a machine learning model from a plurality of candidate-programs, specifying, for each of the plurality of candidate-programs generated using a program-component included in any of a plurality of program-component sets, a first proficiency-level of a user for a first program-component set which includes a first program-component used in the candidate-program, the first proficiency-level is based on proficiency-level information which indicates a proficiency-level of the user related to use of each of the plurality of program-component sets and is determined based on a use record of the plurality of program-component sets in an editing process of the candidate-program by the user and a change in performance of the candidate-program by the editing process, and determining, for each of the plurality of candidate-programs, a priority to present the candidate-program to the user, based on the specified first proficiency-level.

### CROSS-REFERENCE TO RELATED APPLICATION

This application is based upon and claims the benefit of priority of the prior Japanese Patent Application No. 2022-168993, filed on Oct. 21, 2022, the entire contents of which are incorporated herein by reference.

### FIELD

The embodiments discussed herein are related to a computer-readable recording medium storing a machine learning support program, a machine learning support method, and an information processing apparatus.

### BACKGROUND

In machine learning, by using software called automated machine learning (AutoML), a part of process for the machine learning may be automated. For example, a computer that executes AutoML (AutoML system) receives a dataset and task setting information from a user. By using the received datasets and task setting information, the AutoML system generates a plurality of pipelines (candidate pipelines). The pipeline is a program for generating a prediction model corresponding to a task designated by the user, by using the dataset input by the user.

After generating the candidate pipeline, the AutoML system generates a model by using the generated candidate pipeline, and evaluates the generated model, for example. Among the candidate pipelines, the AutoML system selects a pipeline that generates a model with the highest accuracy, and presents the selected pipeline to the user. The user may improve the accuracy of the model generated by the pipeline by editing the pipeline presented from the AutoML system.

As a technique for improving efficiency of machine learning, for example, an analysis apparatus capable of efficiently constructing a prediction model with high prediction accuracy is proposed.

Japanese Laid-open Patent Publication No. 2018-190126 is disclosed as related art.

### SUMMARY

According to an aspect of the embodiments, a non-transitory computer-readable recording medium storing a machine learning support program causing a computer to execute a process, the process includes receiving, by a machine learning support system, an instruction to generate a machine learning model from a plurality of candidate programs, specifying, for each of the plurality of candidate programs generated using a program component included in any of a plurality of program component sets, a first proficiency level of a user for a first program component set which includes a first program component used in the candidate program, the first proficiency level is based on proficiency level information which indicates a proficiency level of the user related to use of each of the plurality of program component sets and is determined based on a use record of the plurality of program component sets in an editing process of the candidate program by the user and a change in performance of the candidate program by the editing process, and determining, for each of the plurality of candidate programs, a priority to present the candidate program to the user, based on the specified first proficiency level.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a machine learning support method according to a first embodiment;

FIG. 2 is a diagram illustrating an example of a system configuration according to a second embodiment;

FIG. 3 is a diagram illustrating an example of hardware of a machine learning support system;

FIG. 4 is a diagram illustrating an example of inappropriate pipeline presentation;

FIG. 5 is a block diagram illustrating an example of a function of each device;

FIG. 6 is a diagram illustrating an example of a procedure of a pipeline generation process;

FIG. 7 is a diagram illustrating an example of a proficiency level update;

FIG. 8 is a flowchart illustrating an example of a procedure of a proficiency level calculation process;

FIG. 9 is a diagram illustrating an example of an extraction process of an added program code line;

FIG. 10 is a diagram illustrating an example of analysis of a program code line by an AST;

FIG. 11 is a flowchart illustrating an example of a procedure of a number-of-elements counting process;

FIG. 12 is a diagram illustrating an example of a proficiency level update process;

FIG. 13 is a diagram illustrating an example of pipeline presentation based on a proficiency level of a user;

FIG. 14 is a diagram illustrating an example of a calculation result of a feature of a package for each candidate pipeline;

FIG. 15 is a diagram illustrating an example of a priority calculation;

FIG. 16 is a diagram illustrating an example of a priority calculation in a case where there is no large difference between proficiency levels;

FIG. 17 is a diagram illustrating an example of a priority calculation in a case where there is no large difference between features of pipelines being used; and

FIG. 18 is a flowchart illustrating an example of a procedure of a presentation pipeline selection process.

### DESCRIPTION OF EMBODIMENTS

In some cases, it is difficult for the user to edit the pipeline presented from AutoML. For example, the pipeline is generated by using various packages. The package is a collection of program components usable in the pipeline. In a case where a pipeline generated by using a package that is not used by the user in the past is presented, the user has to check an operation of a function or the like provided by the package to improve the pipeline, and it takes time to perform editing work. Such a problem occurs not only in a program called a pipeline but also in a system in which a machine learning program is automatically generated and the program is edited by a user.

Hereinafter, the embodiments of techniques capable to present a program that is easily edited by a user will be described with reference to the drawings. Each embodiment may be implemented by combining a plurality of embodiments within a range without contradiction.

### First Embodiment

A first embodiment is a machine learning support method capable of preferentially presenting, to a user, a program that is easily edited by the user when automatically generating a program for generating a machine learning model.

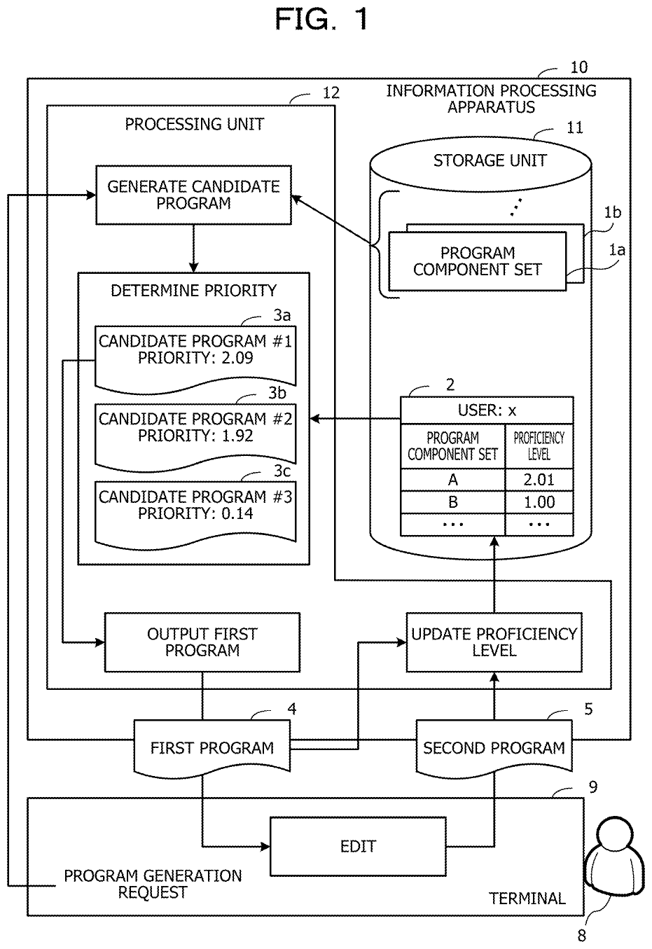

FIG. 1 illustrates an example of a machine learning support method according to the first embodiment. FIG. 1 illustrates an information processing apparatus 10 that performs the machine learning support method. For example, by executing a machine learning support program, the information processing apparatus 10 may implement the machine learning support method.

The information processing apparatus 10 is coupled to a terminal 9 used by a user 8 via, for example, a network. According to a program generation request from the terminal 9, the information processing apparatus 10 may automatically generate a program for generating a machine learning model. At this time, the information processing apparatus 10 generates a plurality of candidate programs 3a, 3b, and 3c, and presents, to the user 8 as a process result, a program that is easily edited by the user 8 among the candidate programs 3a, 3b, and 3c.

The information processing apparatus 10 includes a storage unit 11 and a processing unit 12. The storage unit 11 is, for example, a storage device or a memory included in the information processing apparatus 10. The processing unit 12 is, for example, a processor or an arithmetic circuit included in the information processing apparatus 10.

The storage unit 11 stores a plurality of program component sets 1a, 1b, . . . and proficiency level information 2. Each of the plurality of program component sets 1a, 1b, . . . includes one or more program components usable for a program for generating a machine learning model. The program component is a function, a class, a variable, or the like. The program component sets 1a, 1b, . . . may be referred to as a library, a package, or the like. The proficiency level information 2 is information indicating a proficiency level of the user 8 related to a use of each of the plurality of program component sets 1a, 1b, . . . . The proficiency level information 2 is determined based on a use record of each of the plurality of program component sets 1a, 1b, . . . in a case where the user 8 performs an editing process of editing a program for generating a machine learning model and a change in performance of the machine learning model. The change in performance of the machine learning model is a change in performance (for example, prediction accuracy of the machine learning model) of the machine learning model generated by the program for generating the machine learning model before and after the editing process by the user 8.

According to a program generation request based on an instruction from the user 8, the processing unit 12 uses a program component included in any of the plurality of program component sets 1a, 1b, . . . to generate the plurality of candidate programs 3a, 3b, and 3c for generating the machine learning model. Next, for each of the plurality of candidate programs 3a, 3b, and 3c, the processing unit 12 specifies a first proficiency level of the user 8 for a first program component set including a first program component being used, for example, based on the proficiency level information 2.

The processing unit 12 determines a priority to present each of the plurality of candidate programs 3a, 3b, and 3c to the user 8 based on the specified first proficiency level. For example, the processing unit 12 calculates a feature indicating an importance degree of the first program component set in a first candidate program of a determination target of the priority. The feature is, for example, a term frequency-inverse document frequency (TF-IDF).

Next, the processing unit 12 determines a priority of the first candidate program based on the feature of the first program component set in the first candidate program and the first proficiency level of the user 8 for the first program component set. For example, the processing unit 12 determines the priority based on a product of the feature and the first proficiency level. For example, in a case where there are a plurality of first program components used in the first candidate program, the processing unit 12 sets, as the priority of the first candidate program, a sum of the products of the features and the first proficiency levels of the respective first program components.

Based on the priority of each of the plurality of candidate programs 3a, 3b, and 3c, the processing unit 12 outputs at least one of the plurality of candidate programs as a first program 4 of a generation result in accordance with the program generation request. For example, the processing unit 12 transmits a candidate program having the highest priority (the candidate program 3a in the example in FIG. 1) as the first program 4 to the terminal 9 used by the user 8.

The user 8 uses the terminal 9 to edit the first program 4. The terminal 9 transmits a second program 5 obtained by editing the first program 4 to the information processing apparatus 10. The editing of the first program 4 may be performed in a workspace (memory region for work) in the information processing apparatus 10. In this case, an editing instruction by the user 8 is transmitted from the terminal 9 to the information processing apparatus 10, and the first program 4 is edited by the processing unit 12. After the user 8 inputs an instruction to end the editing to the information processing apparatus 10 via the terminal 9, the processing unit 12 acquires the edited program in the workspace as the second program 5.

After the first program 4 is edited by the user 8 and the second program 5 is generated, the processing unit 12 specifies a second program component set including a second program component added to the second program 5. The processing unit 12 updates a second proficiency level of the user 8 for the second program component set.

For example, the processing unit 12 calculates a difference between a first evaluation value indicating an evaluation result of performance of a first model generated by the first program 4 and a second evaluation value indicating an evaluation result of performance of a second model generated by the second program 5. Based on the difference between the first evaluation value and the second evaluation value, the processing unit 12 calculates an increase amount of the second proficiency level of the user 8 for the second program component set. The processing unit 12 adds the calculated increase amount to the second proficiency level of the user for the second program component set in the proficiency level information 2.

The processing unit 12 may calculate the increase amount of the second proficiency level of the user for the second program component set, based on the number of second program components added to the second program 5 and included in the second program component set, and the difference between the first evaluation value and the second evaluation value. For example, the processing unit 12 sets a value obtained by multiplying the difference between the first evaluation value and the second evaluation value by the number of second program components, as the increase amount of the second proficiency level of the user for the second program component set.

In this manner, the priority of each of the plurality of candidate programs 3a, 3b, and 3c is determined based on the proficiency levels of the user 8 for the plurality of program component sets 1a, 1b, . . . . Based on the priority, at least one candidate program is output as the first program 4. As a result, the information processing apparatus 10 may output a program that is easily edited by the user 8 as the first program 4. For example, a candidate program generated by using a program component set having a high proficiency level of the user 8 is output as the first program 4. Thus, the user 8 may easily grasp contents of the first program 4, and may quickly specify a portion to be improved in the first program 4. As a result, the editing work of the first program 4 is facilitated.

For the calculation of the priority, it is possible to use not only the proficiency level but also the feature of the program component set in each of the plurality of candidate programs 3a, 3b, and 3c. Thus, in a case where there is no difference in proficiency level of the program component set including the program components used in the plurality of candidate programs 3a, 3b, and 3c, a candidate program using a larger number of program components included in a program component set having a large feature has a higher priority. Thus, a candidate program generated by using a large number of program components included in a program component set having a high importance level is output as the first program 4. As a result, for example, the user 8 may efficiently proceed with the editing work for improving the first program 4 by preferentially determining suitability of a program component of a program component set having a large feature (for example, frequently used).

By updating the second proficiency level of the user 8 for the second program component set including the second program component added to the second program 5, the processing unit 12 may improve accuracy of a proficiency level indicated by the proficiency level information 2. As the accuracy of the proficiency level is higher, accuracy of calculating the priority of the candidate programs 3a, 3b, and 3c using the proficiency level is also improved.

For example, the difference between the first evaluation value indicating the evaluation result of the performance of the first model generated by the first program 4 and the second evaluation value indicating the evaluation result of the performance of the second model generated by the second program 5 is used to update the second proficiency level. For example, in a case where the second evaluation value is sufficiently larger than the first evaluation value, it is considered that the user 8 well understands how to use the program component set including the program component added to the second program 5. Therefore, by calculating the increase amount of the second proficiency level of the user 8 for the second program component set based on the difference between the first evaluation value and the second evaluation value, the processing unit 12 may improve the accuracy of the proficiency level.

For example, the processing unit 12 may use the number of second program components added to the second program 5 and included in the second program component set to calculate the increase amount of the second proficiency level of the user. Thus, the processing unit 12 may increase the increase amount of the second proficiency level of the second program component set, which is frequently used. As a result, the accuracy of the proficiency level is improved.

After presenting the first program 4 illustrated in FIG. 1 to the user 8, the processing unit 12 may obtain performance of each of the plurality of candidate programs 3a, 3b, and 3c. The performance of each of the plurality of candidate programs 3a, 3b, and 3c is, for example, prediction accuracy of a model generated by each of the plurality of candidate programs 3a, 3b, and 3c. In this case, the processing unit 12 presents a candidate program having the highest performance to the user 8. Thus, in editing the first program 4, the user 8 may efficiently perform the work of improving the first program 4 by referring to contents of the candidate program having high performance.

### Second Embodiment

A second embodiment is a system that presents, to a user, a pipeline that is easily edited by the user and a pipeline capable of creating a model having high accuracy, among programs (hereinafter, referred to as pipelines) for generating a machine learning model generated by AutoML. By presenting the pipeline that is easily edited by the user and the pipeline capable of creating the model having high accuracy in this manner, it is possible to present a pipeline in consideration of both accuracy and ease of editing by the user.

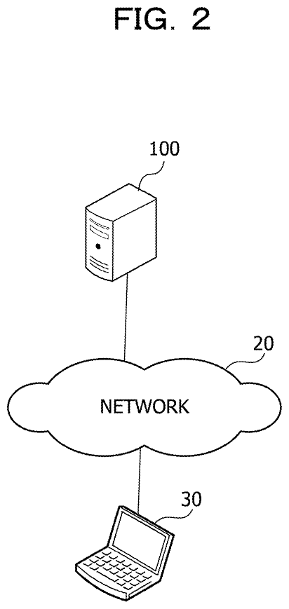

FIG. 2 is a diagram illustrating an example of a system configuration according to the second embodiment. A machine learning support system 100 and a terminal 30 are coupled to each other via the network 20. The machine learning support system 100 is a computer that automatically generates a pipeline for machine learning by AutoML. The terminal 30 is a computer used by a user who creates a model for machine learning.

By using the terminal 30, the user transmits a task of machine learning and a dataset for the machine learning to the machine learning support system 100, and acquires a pipeline automatically generated by AutoML. The user operates the terminal 30 to correct the automatically generated pipeline in accordance with the purpose of the user, and generates a machine learning program for final model generation.

The machine learning support system 100 generates a plurality of candidate pipelines based on the task and the dataset acquired from the terminal 30. Based on a result of editing the pipeline by the user, the machine learning support system 100 presents, to the user, a candidate pipeline that is easily edited by the user, among the generated candidate pipelines. Among the generated candidate pipelines, the machine learning support system 100 also presents, to the user, a pipeline capable of generating a model having the highest accuracy.

For example, the user may easily generate a pipeline having higher accuracy, by applying a function or the like of a pipeline capable of generating a model having the highest accuracy to a pipeline that is easily edited.

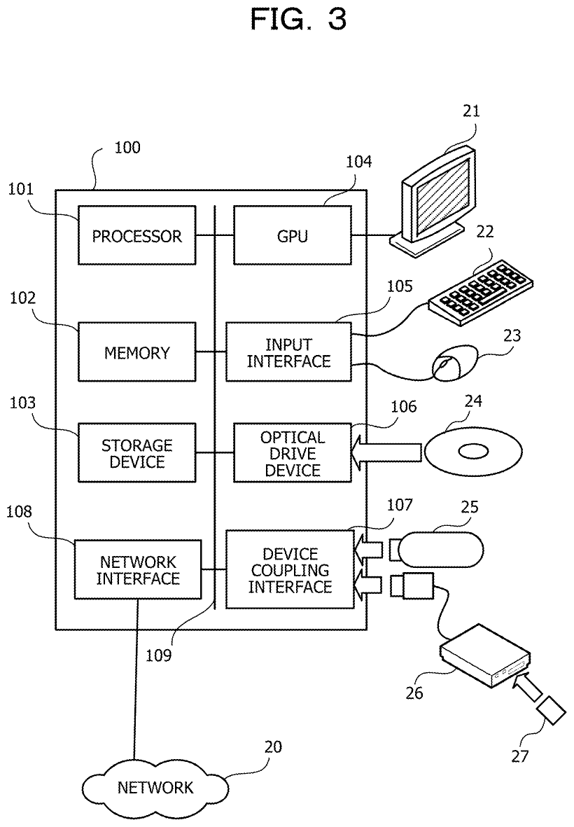

FIG. 3 illustrates an example of hardware of a machine learning support system. The machine learning support system 100 is entirely controlled by a processor 101. A memory 102 and a plurality of peripheral devices are coupled to the processor 101 via a bus 109. The processor 101 may be a multiprocessor. The processor 101 is, for example, a central processing unit (CPU), a microprocessor unit (MPU), or a digital signal processor (DSP). At least a part of a function realized by the processor 101 executing a program may be realized by an electronic circuit such as an application-specific integrated circuit (ASIC), and a programmable logic device (PLD).

The memory 102 is used as a main storage device of the machine learning support system 100. The memory 102 temporarily stores at least a part of an operating system (OS) program or an application program to be executed by the processor 101. The memory 102 stores various types of data to be used for a process by the processor 101. As the memory 102, for example, a volatile semiconductor storage device such as a random-access memory (RAM) is used.

The peripheral devices coupled to the bus 109 include a storage device 103, a graphics processing unit (GPU) 104, an input interface 105, an optical drive device 106, a device coupling interface 107, and a network interface 108.

The storage device 103 writes and reads data electrically or magnetically to a built-in recording medium. The storage device 103 is used as an auxiliary storage device of the machine learning support system 100. The storage device 103 stores an OS program, an application program, and various types of data. As the storage device 103, for example, a hard disk drive (HDD) or a solid-state drive (SSD) may be used.

The GPU 104 is an arithmetic device that performs an image process, and is also referred to as a graphic controller. A monitor 21 is coupled to the GPU 104. The GPU 104 displays images on a screen of the monitor 21 in accordance with a command from the processor 101. As the monitor 21, a display device, a liquid crystal display device, or the like using organic electro luminescence (EL) is used.

A keyboard 22 and a mouse 23 are coupled to the input interface 105. The input interface 105 transmits to the processor 101 signals transmitted from the keyboard 22 and the mouse 23. The mouse 23 is an example of a pointing device, and other pointing devices may be used. An example of the other pointing device includes a touch panel, a tablet, a touch pad, a track ball, or the like.

The optical drive device 106 reads data recorded in an optical disc 24 or writes data to the optical disc 24 by using laser light or the like. The optical disc 24 is a portable-type recording medium in which data is recorded such that the data is readable by reflection of light. Examples of the optical disc 24 include a Digital Versatile Disc (DVD), a DVD-RAM, a compact disc read-only memory (CD-ROM), a CD-recordable (CD-R), a CD-rewritable (CD-RW), and the like.

The device coupling interface 107 is a communication interface for coupling the peripheral device to the machine learning support system 100. For example, a memory device 25 or a memory reader and writer 26 may be coupled to the device coupling interface 107. The memory device 25 is a recording medium in which the function of communication with the device coupling interface 107 is provided. The memory reader and writer 26 is a device that writes data to a memory card 27 or reads data from the memory card 27. The memory card 27 is a card-type recording medium.

The network interface 108 is coupled to the network 20. The network interface 108 transmits and receives data to and from another computer or a communication device via the network 20. The network interface 108 is, for example, a wired communication interface that is coupled to a wired communication device such as a switch or a router by a cable. The network interface 108 may be a wireless communication interface that is coupled, by radio waves, to and communicates with a wireless communication device such as a base station or an access point.

With the above hardware configuration, the machine learning support system 100 may realize a process function in the second embodiment. The information processing apparatus 10 described in the first embodiment may also be realized by hardware in the same manner as the hardware of the machine learning support system 100 illustrated in FIG. 3.

The machine learning support system 100 realizes the process function of the second embodiment by executing, for example, a program recorded in a computer-readable recording medium. The program in which process contents to be executed by the machine learning support system 100 are described may be recorded in various recording media. For example, the program to be executed by the machine learning support system 100 may be stored in the storage device 103. The processor 101 loads at least a part of the program in the storage device 103 to the memory 102, and executes the program. The program to be executed by the machine learning support system 100 may be recorded on a portable-type recording medium such as the optical disc 24, the memory device 25, or the memory card 27. The program stored in the portable-type recording medium may be executed after the program is installed in the storage device 103 under the control of the processor 101, for example. The processor 101 may read the program directly from the portable-type recording medium and execute the program.

In AutoML, a plurality of candidate pipelines are generated, and each candidate pipeline is evaluated. By presenting a pipeline having a high evaluation to a user, it is easy for the user to generate a pipeline capable of creating a model having high accuracy. Meanwhile, it takes time to evaluate the candidate pipeline. Therefore, an attempt is made to reduce the time until the user may edit the pipeline.

For example, when the evaluation of the candidate pipelines is executed as a parallel process, the time taken to evaluate all the candidate pipelines is reduced. Meanwhile, for example, in a case where a calculation resource is insufficient, it is difficult to utilize the parallel process. Even when the parallel process is executable, in order to determine a candidate pipeline having the highest evaluation, there is a condition in which for all the candidate pipelines, models by the candidate pipelines are generated and evaluation results of prediction accuracy by the models are obtained. Therefore, in a case where there is even one candidate pipeline that takes time to generate and evaluate a model, it takes a long time to present a pipeline to the user.

In a situation where it is difficult to utilize the parallel process, a process of speculatively determining a pipeline to be presented to the user as an alternative (speculative evaluation) is conceivable. In the speculative evaluation, one candidate pipeline is evaluated, and the candidate pipeline is presented to the user. At a timing when all the candidate pipelines are evaluated, in a case where there is a candidate pipeline superior to the pipeline presented earlier, the superior candidate pipeline is presented again to the user. As a result, in a case where a candidate pipeline passed first has the highest score, the user does not have to wait for evaluation of all the candidate pipelines.

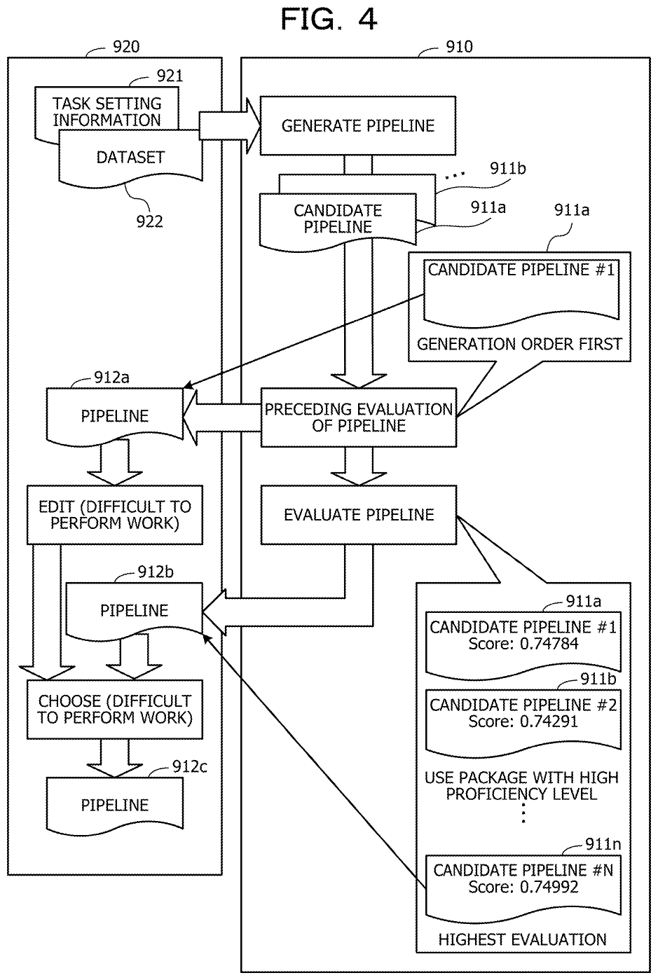

By performing the speculative process in this manner, the machine learning support system 100 may reduce the waiting time until the user receives presentation of the pipeline. By receiving the presentation of the pipeline at an early stage, the user may speed up a start of editing work of the pipeline. Meanwhile, when a program component unknown to the user is used in the pipeline presented at an early stage, it is difficult to perform the editing work. Hereinafter, with reference to FIG. 4, a reason why it is difficult for the user to edit a pipeline presented by AutoML will be described.

FIG. 4 is a diagram illustrating an example of inappropriate pipeline presentation. For example, a terminal 920 used by a user is coupled to a machine learning support system 910. According to an instruction from the user, the terminal 920 transmits task setting information 921 and a dataset 922 to the machine learning support system 910. The machine learning support system 910 performs a pipeline generation process by using a function of AutoML. The generated pipeline is set as candidate pipelines 911a, 911b, . . . . The machine learning support system 910 transmits the candidate pipeline 911a generated first to the terminal 920 as a pipeline 912a as an editing target. A package which is not used by the user is used in the candidate pipeline 911a. The package is an example of a program component set described in the first embodiment. The package may also be referred to as a library. In this case, it is not easy for the user to edit the presented pipeline 912a.

After that, the machine learning support system 910 evaluates the candidate pipelines 911a, 911b, . . . . For example, the machine learning support system 910 generates, for each of the candidate pipelines 911a, 911b, . . . , a model of performing prediction or the like corresponding to a task indicated by the task setting information 921 by using the dataset 922. The machine learning support system 910 executes inference by using the generated model, and checks accuracy of a prediction result. For example, the machine learning support system 910 sets a higher score for a candidate pipeline having higher prediction accuracy. Among all the candidate pipelines 911a, 911b, . . . , the machine learning support system 910 transmits a candidate pipeline 911n having the highest score to the terminal 920 as a pipeline 912b to be used as a reference for editing.

The user checks contents of the pipeline 912b having a high evaluation, chooses an available program component or the like, and applies the selected program component to the pipeline 912a. Thus, a pipeline 912c changed from the pipeline 912a is generated.

In the example illustrated in FIG. 4, it is assumed that the candidate pipeline 911b is generated by using a package that is used by the user in the past, and the user has a high proficiency level in using the package. In a case where a candidate package with a high proficiency level of the package being used is presented to the user, the user may easily edit the candidate package. Meanwhile, in the example illustrated in FIG. 4, the candidate pipeline 911b is not generated first, and the evaluation of the candidate pipeline 911b is not highest. Therefore, the candidate pipeline 911b that is easily edited by the user is not presented to the user.

Therefore, with the machine learning support system 100 according to the second embodiment, a proficiency level of the user for a package used in the candidate pipeline is obtained, and a pipeline to be presented to the user in advance is determined based on the proficiency level. Thus, the pipeline that is easily edited by the user is presented at an early stage, and the editing by the user may efficiently proceed.

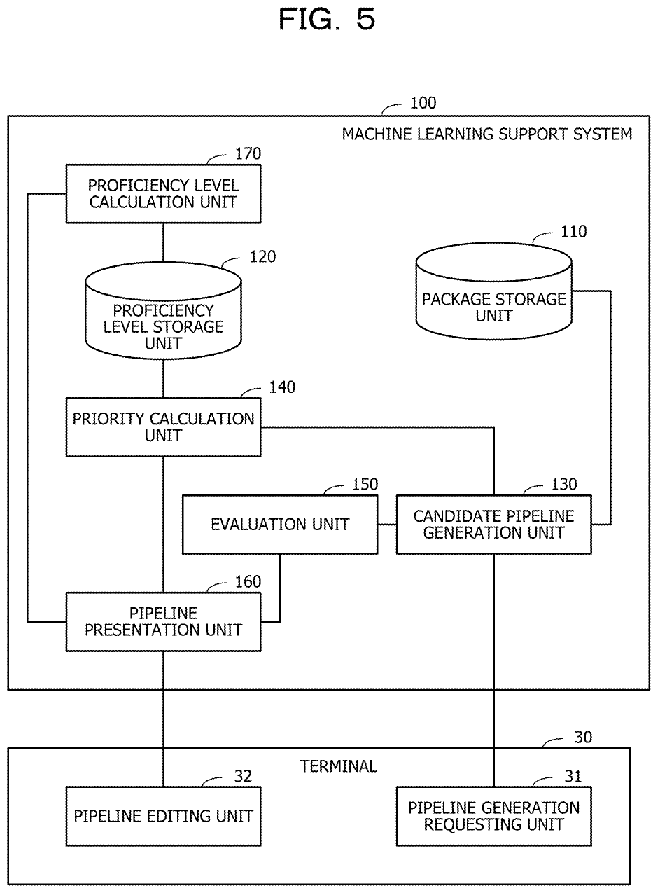

FIG. 5 is a block diagram illustrating an example of a function of each device. The machine learning support system 100 includes a package storage unit 110, a proficiency level storage unit 120, a candidate pipeline generation unit 130, a priority calculation unit 140, an evaluation unit 150, a pipeline presentation unit 160, and a proficiency level calculation unit 170.

The package storage unit 110 stores a plurality of packages to be used to generate a candidate pipeline. In some cases, the plurality of packages including program components for realizing the same function may be stored in the package storage unit 110. For example, in some cases, functions to be implemented in two or more packages created by different creators may overlap with each other. Both of the previous version package and the new version package created by the same creator may be stored in the package storage unit 110.

The proficiency level storage unit 120 stores a proficiency level of a user with respect to a package. Every time a pipeline using the package is edited, the proficiency level calculation unit 170 updates the proficiency level of the user with respect to the package.

By using the package stored in the package storage unit 110, the candidate pipeline generation unit 130 generates a plurality of candidate pipelines which may generate a model capable of realizing a task designated by the user.

For the candidate pipelines generated by the candidate pipeline generation unit 130, the priority calculation unit 140 calculates a presentation priority in consideration of the ease of editing by the user. For example, the priority calculation unit 140 calculates a priority of the candidate pipeline based on a proficiency level of the user for the package used in the candidate pipeline.

The evaluation unit 150 evaluates accuracy of each of the generated candidate pipelines. The accuracy of the candidate pipeline is represented by, for example, prediction accuracy by a model generated by using the candidate pipeline. For example, the accuracy of the candidate pipeline is quantified as a score.

The pipeline presentation unit 160 transmits information indicating a pipeline to the terminal 30 used by the user, and edits the pipeline in accordance with an input from the terminal 30. For example, the pipeline presentation unit 160 transmits information indicating a candidate pipeline having the highest priority calculated by the priority calculation unit 140 to the terminal 30 as a pipeline of an editing target. The pipeline presentation unit 160 presents the candidate pipeline having the highest accuracy score by the evaluation unit 150 to the user as a reference pipeline.

When the pipeline presented by the pipeline presentation unit 160 is edited by the user, the proficiency level calculation unit 170 calculates a proficiency level of a package used in the pipeline based on the pipeline before and after the editing. Based on the calculated proficiency level, the proficiency level calculation unit 170 updates the proficiency level of the package stored in the proficiency level storage unit 120.

The terminal 30 includes a pipeline generation requesting unit 31 and a pipeline editing unit 32. Based on an instruction from the user, the pipeline generation requesting unit 31 transmits a pipeline generation request to the machine learning support system 100. The pipeline generation request includes task setting information indicating a task of machine learning and a dataset used for the machine learning.

According to an input from the user, the pipeline editing unit 32 edits the pipeline presented from the machine learning support system 100. For example, the pipeline editing unit 32 displays the pipeline presented by the machine learning support system 100. The pipeline editing unit 32 transmits an editing content for the pipeline to the machine learning support system 100.

The line coupling each element illustrated in FIG. 5 indicate some communication paths, and communication paths other than the communication paths illustrated in FIG. 5 may also be set. The function of each of the elements illustrated in FIG. 5 may be implemented, for example, by causing a computer to execute a program module corresponding to the element.

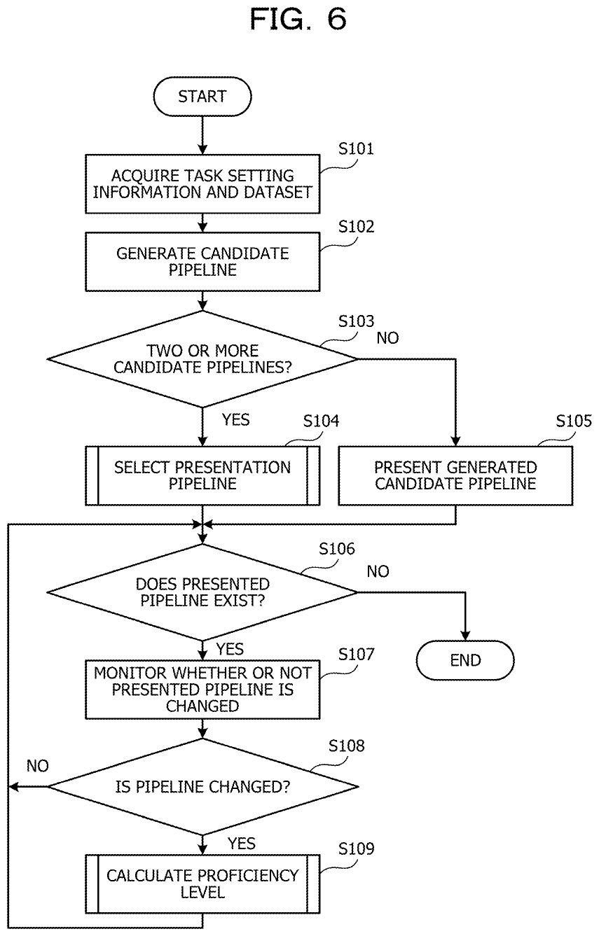

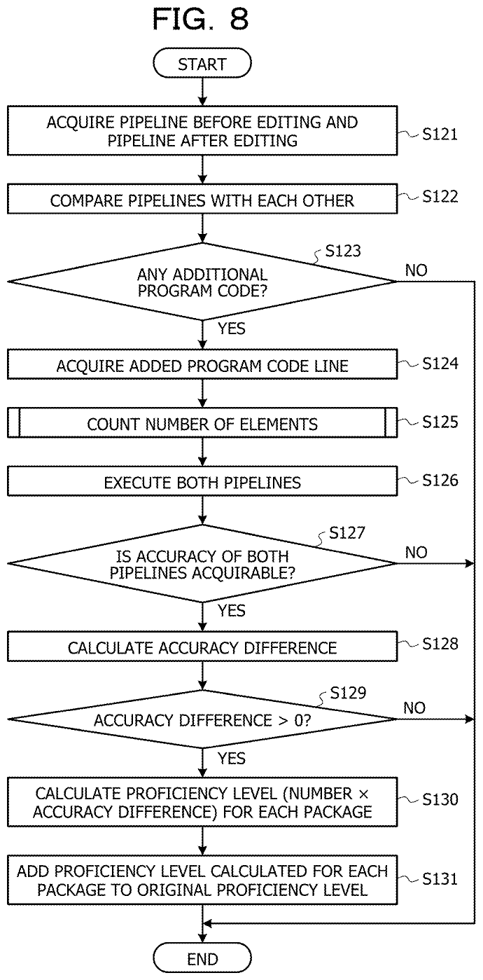

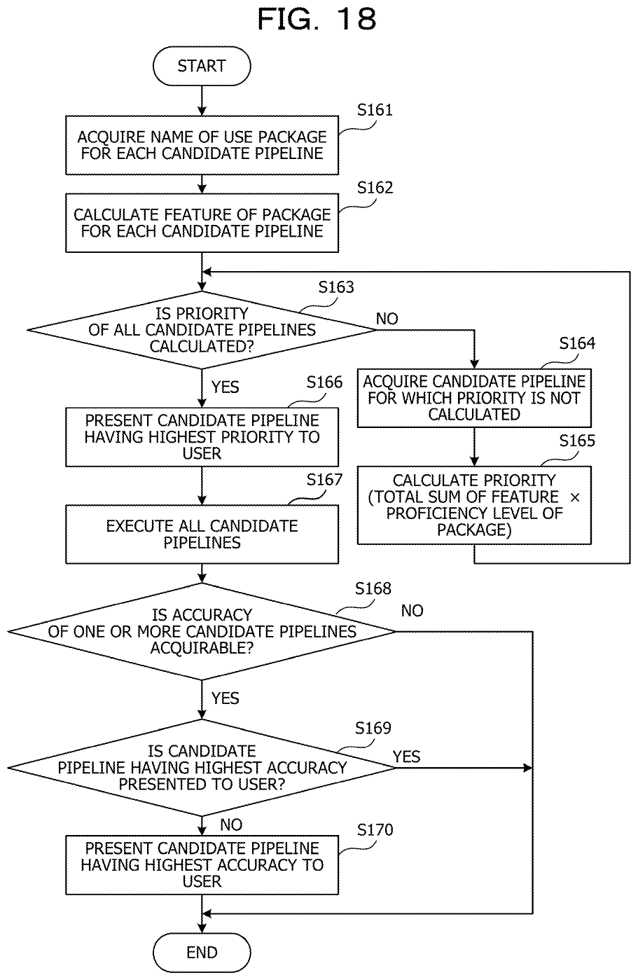

Hereinafter, a procedure of the pipeline generation process by the system having the configuration illustrated in FIG. 5 will be described with reference to FIG. 6. FIG. 6 is a diagram illustrating an example of a procedure of a pipeline generation process. Hereinafter, the processes illustrated in FIG. 6 will be described in order of operation numbers.
[operation S101] The candidate pipeline generation unit 130 acquires a pipeline generation request including task setting information and a dataset from the terminal 30.
[operation S102] The candidate pipeline generation unit 130 generates a candidate pipeline. For example, the candidate pipeline generation unit 130 generates, by AutoML using a package, a plurality of candidate pipelines capable of generating a model for realizing a task designated by using the acquired dataset. The candidate pipeline generation unit 130 transmits the generated candidate pipeline to the priority calculation unit 140 and the evaluation unit 150.
[operation S103] The priority calculation unit 140 determines whether or not there are two or more generated candidate pipelines. In a case where there are two or more candidate pipelines, the priority calculation unit 140 shifts the process to operation S104. In a case where there is only one candidate pipeline, the priority calculation unit 140 shifts the process to operation S105.
[operation S104] The priority calculation unit 140, the evaluation unit 150, and the pipeline presentation unit 160 cooperate with each other to execute a presentation pipeline selection process. Details of the presentation pipeline selection process will be described below (see FIG. 18). After that, the priority calculation unit 140 shifts the process to operation S106.
[operation S105] The pipeline presentation unit 160 presents the generated candidate pipeline to a user as a pipeline of an editing target. For example, the pipeline presentation unit 160 transmits information indicating contents of the candidate pipeline to the terminal 30 used by the user.
[operation S106] The pipeline presentation unit 160 determines whether or not the presented pipeline exists. A case where the presented pipeline exists is a case where the presented pipeline remains as the editing target and an instruction to end editing is not received. In a case where a pipeline exists, the pipeline presentation unit 160 shifts the process to operation S107. In a case where the presentation of the pipeline is ended, the pipeline presentation unit 160 ends the pipeline generation process.
[operation S107] The pipeline presentation unit 160 monitors whether or not contents of the presented pipeline are changed. For example, the pipeline presentation unit 160 receives an editing instruction for the contents of the presented pipeline from the terminal 30. According to the editing instruction, the pipeline presentation unit 160 changes the contents of the pipeline.
[operation S108] The pipeline presentation unit 160 determines whether or not the contents of the presented pipeline are changed. In a case where the contents of the pipeline are changed, the pipeline presentation unit 160 shifts the process to operation S109. In a case where the contents of the pipeline are not changed, the pipeline presentation unit 160 shifts the process to operation S106.
[operation S109] The proficiency level calculation unit 170 performs a proficiency level calculation process for the user on a package used to generate the presented pipeline. Details of the proficiency level calculation process will be described below (refer to FIG. 8). After end of the proficiency level calculation process, the proficiency level calculation unit 170 shifts the process to operation S106.

In this manner, the machine learning support system 100 may present the pipeline to the user, and may calculate the proficiency level of the user for the package based on the editing result of the pipeline. Every time the proficiency level is calculated, the proficiency level stored in the proficiency level storage unit 120 is updated.

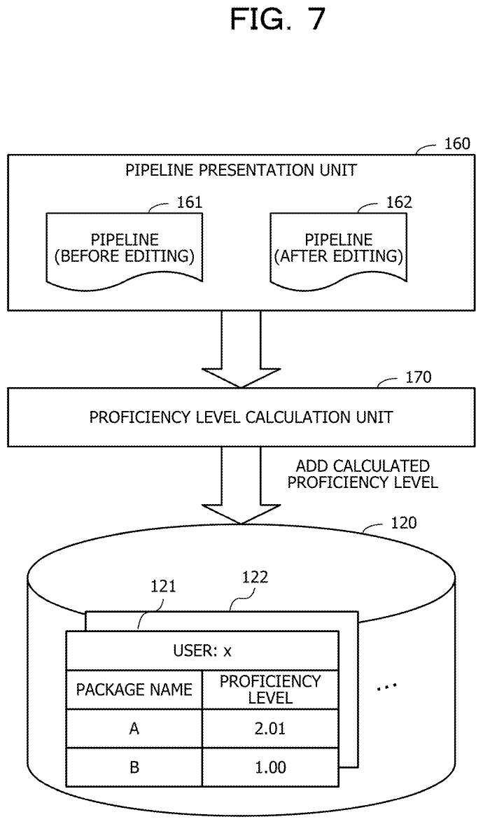

FIG. 7 is a diagram illustrating an example of a proficiency level update. The pipeline presentation unit 160 manages a pipeline 161 before editing and a pipeline 162 after the editing. The pipeline presentation unit 160 transmits these two pipelines 161 and 162 to the proficiency level calculation unit 170. By using difference information between the two pipelines 161 and 162, the proficiency level calculation unit 170 analyzes change details, and specifies a package that provides a function newly added by a user with editing. The proficiency level calculation unit 170 evaluates accuracy of each of the two pipelines 161 and 162. The accuracy is represented by accuracy of a model generated by using each of the pipelines 161 and 162. Based on the package that provides the added function and a difference in accuracy between the respective pipelines 161 and 162 before and after editing, the proficiency level calculation unit 170 calculates a proficiency level of the user for the package.

Proficiency level management tables 121, 122, . . . for each user are stored in the proficiency level storage unit 120. A user name of the corresponding user is set in each of the proficiency level management tables 121, 122, . . . . In each of the proficiency level management tables 121, 122, . . . , a proficiency level of the user for the corresponding package is set in association with a package name.

The proficiency level calculation unit 170 adds the calculated proficiency level of the package to a value of a proficiency level of the corresponding package in a proficiency level management table corresponding to the user who edits the pipelines 161 and 162. By adding the proficiency level in this manner, the proficiency level reflecting the proficiency level calculated in the past is obtained. For example, the value of the proficiency level for the package repeatedly used by the user is increased.

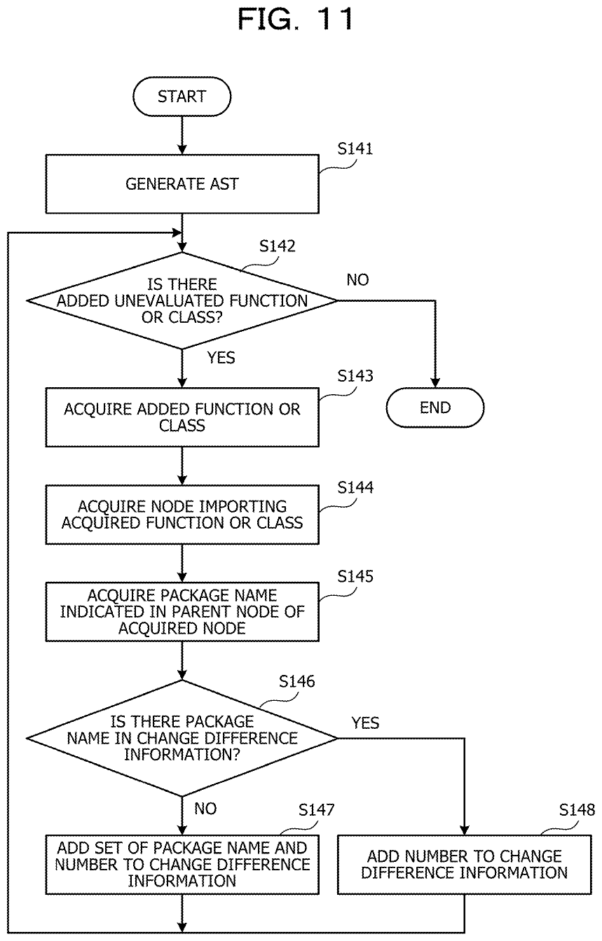

FIG. 8 is a flowchart illustrating an example of a procedure of a proficiency level calculation process. Hereinafter, the processes illustrated in FIG. 8 will be described in order of operation numbers.
[operation S121] The proficiency level calculation unit 170 acquires the pipeline 161 before editing and the pipeline 162 after the editing.
[operation S122] The proficiency level calculation unit 170 compares both of the acquired pipelines.
[operation S123] The proficiency level calculation unit 170 determines whether or not there is a program code added by the editing. In a case where there is an added program code, the proficiency level calculation unit 170 shifts the process to operation S124. When there is no added program code, the proficiency level calculation unit 170 ends the proficiency level calculation process.
[operation S124] The proficiency level calculation unit 170 acquires an added program code line.
[operation S125] The proficiency level calculation unit 170 counts the number of elements belonging to any package included in the acquired program code line. Details of a number-of-elements counting process will be described below (refer to FIG. 11).
[operation S126] The proficiency level calculation unit 170 executes both of the acquired pipelines. For example, the proficiency level calculation unit 170 generates a model for predicting predetermined information, for each of the two pipelines 161 and 162 by using a dataset acquired from a user. By using the dataset acquired from the user, the proficiency level calculation unit 170 predicts the predetermined information by the generated model, and calculates a ratio at which the prediction result matches a correct answer. A matching ratio is accuracy of the corresponding pipeline.
[operation S127] The proficiency level calculation unit 170 determines whether or not the accuracy of both of the pipelines may be acquired. A case where the accuracy may not be acquired is, for example, a case where an error occurs at a time of execution of a pipeline and the process is ended without generating the model. Even in a case where the user deletes a portion to be used for accuracy evaluation from the pipeline by editing, the accuracy acquisition fails. In a case where the accuracy of both of the pipelines may be acquired, the proficiency level calculation unit 170 shifts the process to operation S128. In a case where the accuracy may not be acquired for at least one pipeline, the proficiency level calculation unit 170 ends the proficiency level calculation process.
[operation S128] The proficiency level calculation unit 170 calculates a difference in accuracy between both of the pipelines. For example, the proficiency level calculation unit 170 calculates “accuracy of pipeline after editing−accuracy of pipeline before editing”, and sets the calculation result as the accuracy difference.
[operation S129] The proficiency level calculation unit 170 determines whether or not the accuracy difference is larger than 0 (accuracy difference>0). In a case where the accuracy difference is larger than 0, the proficiency level calculation unit 170 shifts the process to operation S130. In a case where the accuracy difference is equal to or smaller than 0, the proficiency level calculation unit 170 ends the proficiency level calculation process.
[operation S130] The proficiency level calculation unit 170 calculates a proficiency level for each package. For example, the proficiency level is a value obtained by multiplying the number of elements counted as belonging to the package by the accuracy difference (number×accuracy difference), in the counting in operation S125.
[operation S131] The proficiency level calculation unit 170 adds the proficiency level calculated for each package to the original proficiency level already registered in association with the package. After that, the proficiency level calculation unit 170 ends the proficiency level calculation process.

In this manner, every time the user edits the pipeline, the proficiency level of the user for the package including the element added by the editing is updated. In order to specify an element added by editing, first, a program code line added by editing is extracted.

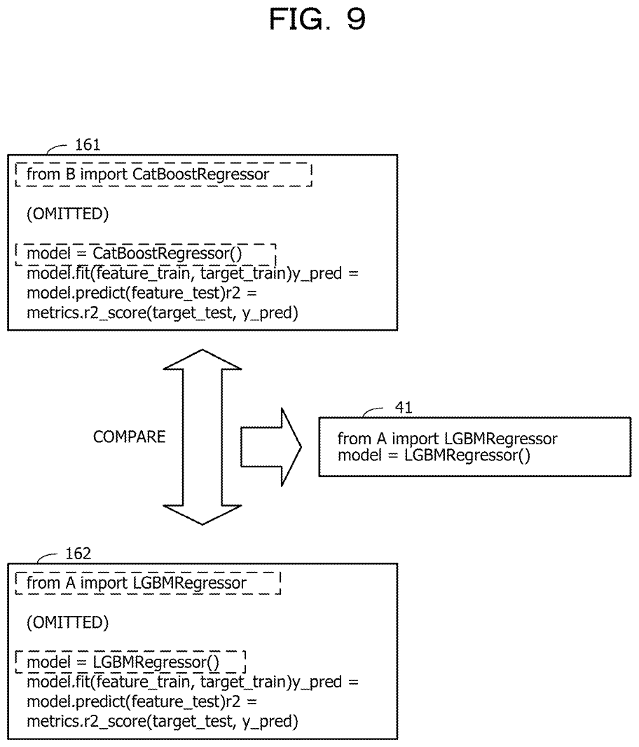

FIG. 9 is a diagram illustrating an example of an extraction process of an added program code line. For example, a program code line of “from B import CatBoostRegressor” in the pipeline 161 before editing is rewritten to “from A import LGBMRegressor” in the pipeline 162 after the editing. A program code line of “model=CatBoostRegressor( )” in the pipeline 161 before the editing is rewritten to “model=LGBMRegressor( )” in the pipeline 162 after the editing.

By comparing the pipelines 161 and 162 before and after the editing in this case, an additional program code line 41 added to the pipeline 162 after the editing is extracted. A process of extracting the additional program code line 41 may be performed by using difference extraction software called a Diff tool, for example.

By analyzing the extracted additional program code line 41, the proficiency level calculation unit 170 may check an element of a package added by the program code line. The analysis of the additional program code line 41 may be performed by, for example, using an abstract syntax tree (AST).

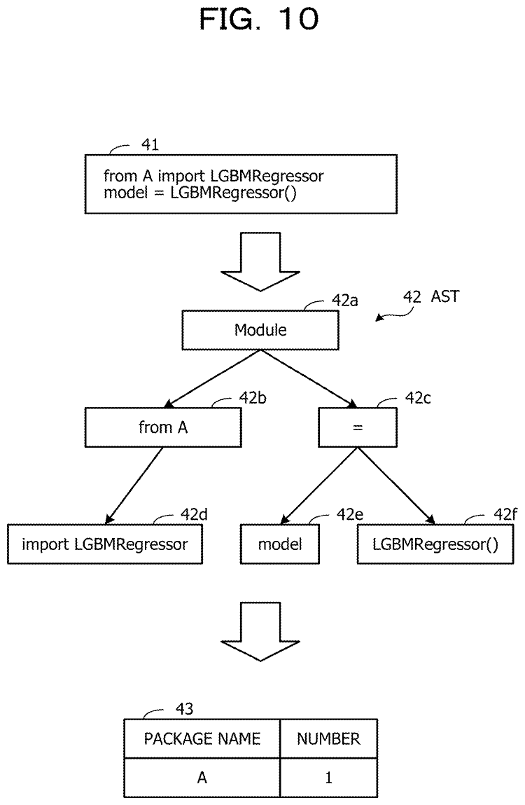

FIG. 10 is a diagram illustrating an example of analysis of a program code line by an AST. For example, the proficiency level calculation unit 170 generates an AST 42 of the additional program code line 41 by using a standard package of Python (registered trademark). The AST 42 includes nodes 42a to 42f corresponding to elements included in the program code line. Each of the nodes 42a to 42f is coupled by a line indicating a relationship between the corresponding elements.

The proficiency level calculation unit 170 interprets contents of the additional program code line 41 by the AST 42. When a reference to an identifier of an element such as a module, a function, or a class belonging to the package is newly added from the additional program code line 41, the proficiency level calculation unit 170 counts the number of elements for each package. The proficiency level calculation unit 170 registers the number of elements for each package in change difference information 43.

In the change difference information 43, the number of elements belonging to a package corresponding to a package name is registered in association with the package name.

FIG. 11 is a flowchart illustrating an example of a procedure of a number-of-elements counting process. Hereinafter, the processes illustrated in FIG. 11 will be described in order of operation numbers.
[operation S141] The proficiency level calculation unit 170 generates the AST 42 of the additional program code line 41.
[operation S142] Among the added functions or classes, the proficiency level calculation unit 170 determines whether or not there is an unevaluated function or class. In a case where there is an unevaluated function or class, the proficiency level calculation unit 170 shifts the process to operation S143. When all of the added functions or classes are evaluated, the proficiency level calculation unit 170 ends the number-of-elements counting process.
[operation S143] By operating the AST 42, the proficiency level calculation unit 170 acquires one unevaluated function or class among the added functions or classes. For example, the proficiency level calculation unit 170 acquires “LGBMRegressor( )” indicated in the node 42f of the AST 42.
[operation S144] The proficiency level calculation unit 170 acquires a node that imports the acquired function or class. For example, the node 42d of the AST 42 is a node that imports “LGBMRegressor( )”. Therefore, the proficiency level calculation unit 170 acquires the node 42d.
[operation S145] The proficiency level calculation unit 170 acquires a package name indicated by a parent node of the acquired node. For example, the proficiency level calculation unit 170 acquires a package name “A” from the node 42b, which is the parent node of the node 42d.
[operation S146] The proficiency level calculation unit 170 determines whether or not the acquired package name is already registered in the change difference information 43. In a case where the package name is not registered, the proficiency level calculation unit 170 shifts the process to operation S147. In a case where the package name is registered, the proficiency level calculation unit 170 shifts the process to operation S148.
[operation S147] The proficiency level calculation unit 170 adds a record (set of a package name and the number) indicating the acquired package name to the change difference information 43. “1” is set in a field of the number in this record. After that, the proficiency level calculation unit 170 shifts the process to operation S142.
[operation S148] For example, the proficiency level calculation unit 170 adds “1” to the number in the record corresponding to the acquired package name in the change difference information 43. After that, the proficiency level calculation unit 170 shifts the process to operation S142.

In this manner, the proficiency level calculation unit 170 generates the change difference information 43 based on the additional program code line 41. For example, the change difference information 43 is stored in the memory 102. Based on the generated change difference information 43 and the accuracy of each of the pipelines 161 and 162 before and after the editing, an increase amount of the proficiency level of the user based on the current editing by the user is determined. The proficiency level of the user with respect to the package is increased by the determined increase amount.

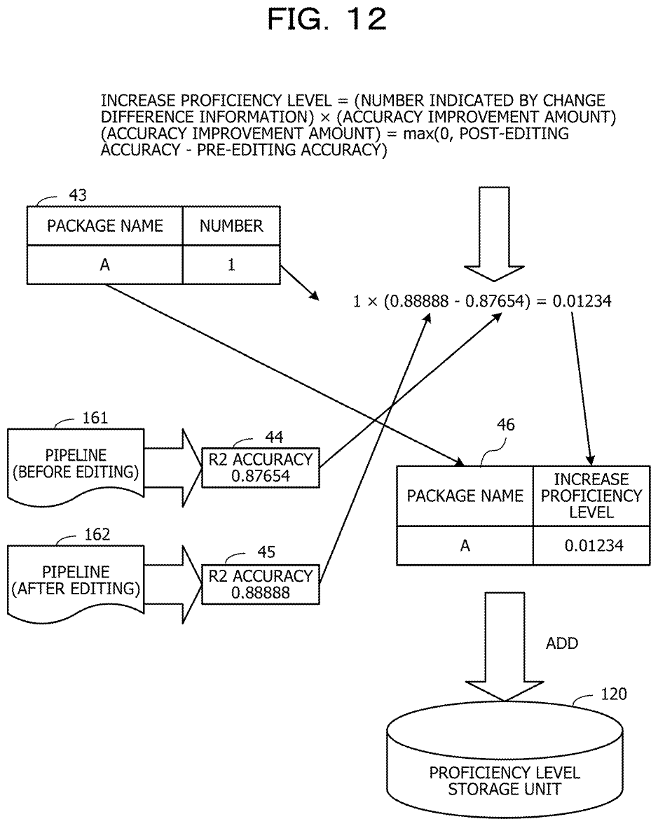

FIG. 12 is a diagram illustrating an example of a proficiency level update process. The proficiency level calculation unit 170 executes each of the pipelines 161 and 162 to generate a model. For example, the proficiency level calculation unit 170 calculates accuracy of the model generated by each of the pipelines 161 and 162. The accuracy is represented by, for example, a coefficient of determination. The coefficient of determination is also referred to as “R²”. Hereinafter, a value indicating the accuracy represented by the coefficient of determination is referred to as “R2 accuracy”.

The R2 accuracy of the pipeline 161 before editing is referred to as pre-editing accuracy 44, and the R2 accuracy of the pipeline 162 after the editing is referred to as post-editing accuracy 45. In the example illustrated in FIG. 12, the pre-editing accuracy 44 is “0.87654” and the post-editing accuracy 45 is “0.88888”.

For example, the proficiency level calculation unit 170 sets the “the number×accuracy improvement amount (difference in accuracy when improved) indicated in the change difference information” for the package as the increase amount (increase proficiency level) of the proficiency level of the package. The accuracy improvement amount is given by “max(0, post-editing accuracy−pre-editing accuracy)”. The “max( )” is a function that returns a larger value among given values. According to the expression indicating the accuracy improvement amount, in a case where the accuracy is degraded after the editing, the improvement amount is “0”.

For example, in the change difference information 43, the number “1” is set for the package name “A”. The increase proficiency level is “1×(0.88888−0.87654)=0.01234”. Therefore, the proficiency level calculation unit 170 registers a set of the package name “A” and the increase proficiency level “0.01234” in the increase proficiency level information 46.

Based on the increase proficiency level information 46, the proficiency level calculation unit 170 updates the information in the proficiency level storage unit 120. For example, the proficiency level calculation unit 170 reads a proficiency level management table of a user who performs the editing from the proficiency level storage unit 120. The proficiency level calculation unit 170 adds the increase proficiency level of the corresponding package name in the increase proficiency level information 46 to a proficiency level of a record corresponding to a package name indicated in the increase proficiency level information 46, in the read proficiency level management table. The proficiency level calculation unit 170 stores the updated proficiency level management table in the proficiency level storage unit 120.

In this manner, every time the pipeline is edited by the user, the proficiency level management table of the user is updated. A value of the increase proficiency level is added to the proficiency level. Therefore, it is possible to determine the proficiency level of each package reflecting the past experience of the user based on the proficiency level management table of the user. Therefore, with the machine learning support system 100, a candidate pipeline using a function or a class provided in a package having a high proficiency level of a user is preferentially presented to the user as a pipeline of an editing target.

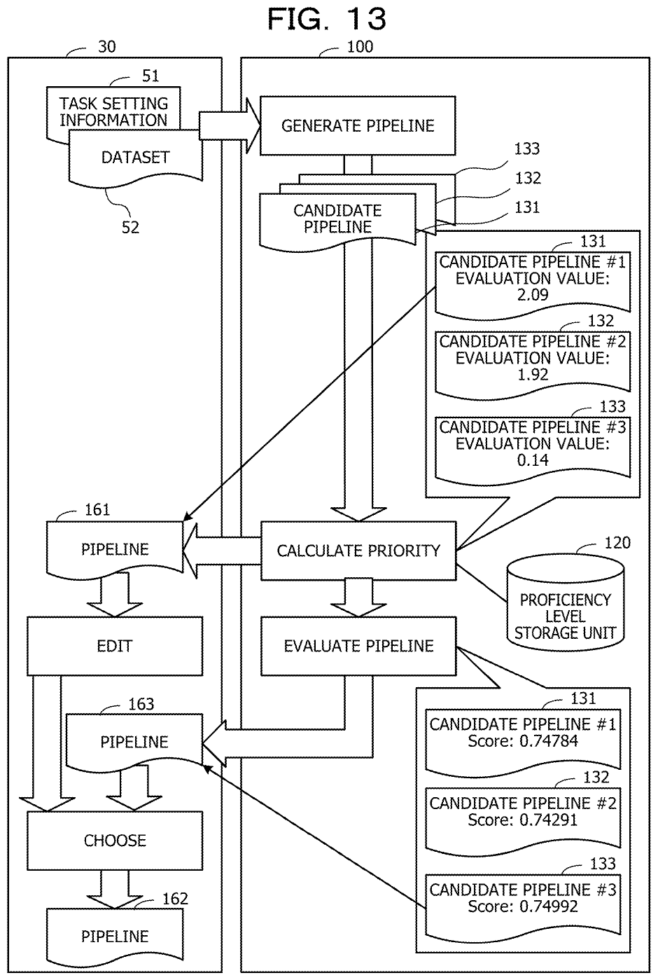

FIG. 13 is a diagram illustrating an example of pipeline presentation based on a proficiency level of a user. For example, the user uses the terminal 30 to transmit a pipeline generation request including task setting information 51 and a dataset 52 to the machine learning support system 100. In the machine learning support system 100, the candidate pipeline generation unit 130 acquires the pipeline generation request. By using a package in the package storage unit 110, the candidate pipeline generation unit 130 generates a plurality of candidate pipelines 131 to 133.

The priority calculation unit 140 refers to a proficiency level management table of the user who uses the terminal 30 that transmits the pipeline generation request from the proficiency level storage unit 120, and calculates a priority of each of the candidate pipelines 131 to 133. The priority is a higher value for a candidate pipeline using more functions or classes provided by a package having a higher proficiency level. In the example illustrated in FIG. 13, the candidate pipeline 131 has the highest priority. Therefore, the pipeline presentation unit 160 transmits contents of the candidate pipeline 131 as the pipeline 161 of an editing target to the terminal 30.

After that, the evaluation unit 150 evaluates accuracy of each of the candidate pipelines 131 to 133, and calculates a score. In the example illustrated in FIG. 13, the candidate pipeline 133 has the highest score. Therefore, the pipeline presentation unit 160 transmits the candidate pipeline 133 as a pipeline 163 of a reference used for correction of the pipeline 161.

After the terminal 30 receives contents of the pipeline 161, the user operates the terminal 30 to edit the pipeline 161. After that, when the terminal 30 receives the pipeline 163, the user checks contents of the pipeline 163, and determines a choice of an available element. When there is an available element, the user replaces a part of the function of the pipeline 161 with an element such as a function or a class indicated in the pipeline 163. Finally, the pipeline 162 after editing is generated.

Hereinafter, the method of calculating the priority of the candidate pipelines 131 to 133 will be described in detail.

Assuming that a candidate pipeline is “a”, the priority calculation unit 140 obtains a priority “f(a)” of all the candidate pipelines by using Expression (1).

$$\\ \begin{matrix}f ( a ) = {\sum }_{p ∈ {P}_{a}} ( feature ( a , p ) \times weight ( p ) ) & ( 1 )\end{matrix}$$

Pₓ is a set of package names included in a pipeline x. “feature(a, p)” is a feature related to a package “p” in a pipeline “a”. “weight(p)” is a value indicating a weight of the package “p”, and a proficiency level of the user for the package “p” is used. In a case where a proficiency level of the user for the package “p” is not included in the proficiency level storage unit 120, the weight is set to “0”.

For example, the priority calculation unit 140 uses TF-IDF to acquire, for each candidate pipeline, a feature of a package used in the candidate pipeline. The TF-IDF is a scale representing that each word included in each document is “how important in the document”. The priority calculation unit 140 sets the document of general TF-IDF calculation as a candidate pipeline, and sets the word as a package name. Thus, it is possible to quantify how important a pipeline used in a candidate pipeline is in the candidate pipeline by using TF-IDF.

The feature “feature (a, p)” of the package “p” in the pipeline “a” is represented by Expression (2).

$$feature ( a , p ) = tfidf ( t , d ) = \frac{{n}_{t , d}}{{\sum }_{s ∈ d} {n}_{s , d}} \times ( log \frac{N}{df ( t )} + 1 ) \qquad ( 2 )$$

In Expression (2), the candidate pipeline “a” is associated with a document “d” of TF-IDF, and the package “p” of the candidate pipeline is associated with a word “t” of TF-IDF. n_{s,d} is an appearance frequency of each word “s” included in the document “d”, in the document “d”. n_{t,d} is an appearance frequency of the word “t” in the document “d”. “df(t)” is the number of documents in which the word “t” appears. N is a total number of documents.

“1” is added to a term of idf in Expression (2) in order to avoid a case where a weight of the package “p” included in all the pipelines is not reflected in “f(a)”, as compared with the general TF-IDF expression. Details of the reason why “1” is added to the term of idf are as follows.

A case where “1” is not added to the term of idf is considered. When the package “p” appears in all the pipelines, the term of idf becomes “0”. At this time, “feature(a, p)” is “0” regardless of a value of a term of tf. For example, the feature of the appearance frequency of a package appearing in all the pipelines is ignored. Even for information in which a certain package exists (n≠0), in the calculation of the feature of the package used in the pipeline, it is desirable to use the information at all times. Therefore, in Expression (2), “1” is added to the term of idf to avoid that the appearance frequency of the package appearing in the pipeline is ignored.

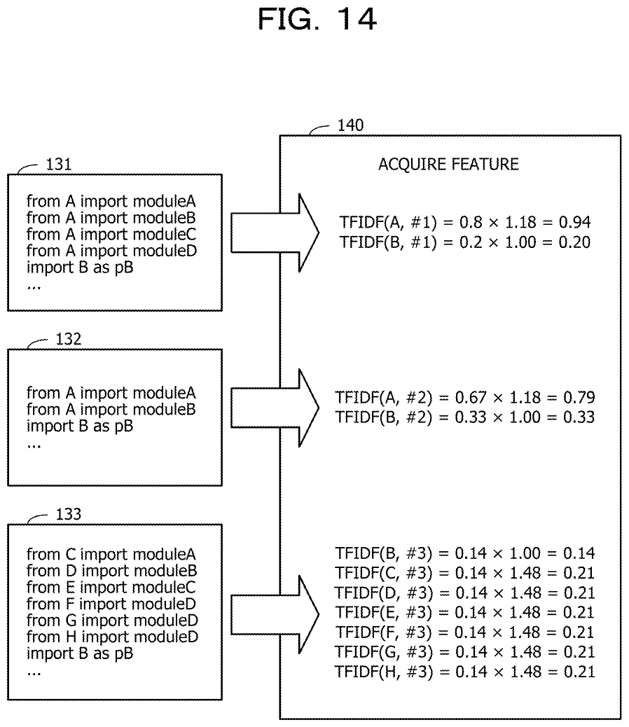

FIG. 14 is a diagram illustrating an example of a calculation result of a feature of a package for each candidate pipeline. In the example illustrated in FIG. 14, an identification number of the candidate pipeline 131 in the machine learning support system 100 is “#1”, an identification number of the candidate pipeline 132 in the machine learning support system 100 is “#2”, and an identification number of the candidate pipeline 133 in the machine learning support system 100 is “#3”.

In the candidate pipeline 131, four elements of the package “A” are used, and one element of the package “B” is used. In the candidate pipeline 132, two elements of the package “A” are used, and one element of the package “B” is used. One element of each of the packages “B”, “C”, “D”, “E”, “F”, “G”, and “H” is used in the candidate pipeline 133.

A value of the term of tf of the package “p” of the candidate pipeline “a” is referred to as “TF(a, p)”. In this case, the value of the term of tf of the package used in each candidate pipeline is as follows. TF(#1, A)=4/5TF(#1, B)=1/5TF(#2, A)=2/3TF(#2, B)=1/3TF(#3, C)=1/7TF(#3, D)=1/7TF(#3, E)=1/7TF(#3, F)=1/7TF(#3, G)=1/7TF(#3, H)=1/7TF(#3, B)=1/7

Assuming that the value of the term of idf of the package “p” is “IDF(A)”, the value of the term of idf of each package is as follows. IDF(A)=log(3/2)+1=1.18IDF(B)=log(3/3)+1=1IDF(C)=log(3/1)+1=1.48IDF(D)=log(3/1)+1=1.48IDF(E)=log(3/1)+1=1.48IDF(F)=log(3/1)+1=1.48IDF(G)=log(3/1)+1=1.48IDF(H)=log(3/1)+1=1.48

A feature of the package “p” used in the candidate pipeline “a” is represented as “TFIDF(p, a)”. At this time, the feature of each package used in the candidate pipeline 131 is as follows. TFIDF(A, #1)=0.8×1.18=0.94TFIDF(B, #1)=0.2×1.00=0.20

The feature of each package used in the candidate pipeline 132 is as follows. TFIDF(A, #2)=0.67×1.18=0.79TFIDF(B, #2)=0.33×1.00=0.33

The feature of each package used in the candidate pipeline 133 is as follows. TFIDF(B, #3)=0.14×1.00=0.14TFIDF(C, #3)=0.14×1.48=0.21TFIDF(D, #3)=0.14×1.48=0.21TFIDF(E, #3)=0.14×1.48=0.21TFIDF(F, #3)=0.14×1.48=0.21TFIDF(G, #3)=0.14×1.48=0.21TFIDF(H, #3)=0.14×1.48=0.21

The package “B” is used in all the candidate pipelines in the example described above, and “IDF (B)” is not “0” but “1”. Thus, in the candidate pipelines 131 to 133, the value of the term of tf of the package “B” is not ignored. For each candidate pipeline, the priority calculation unit 140 calculates a presentation priority based on ease of editing of the candidate pipeline, based on the feature and the proficiency level of each package used in the candidate pipeline.

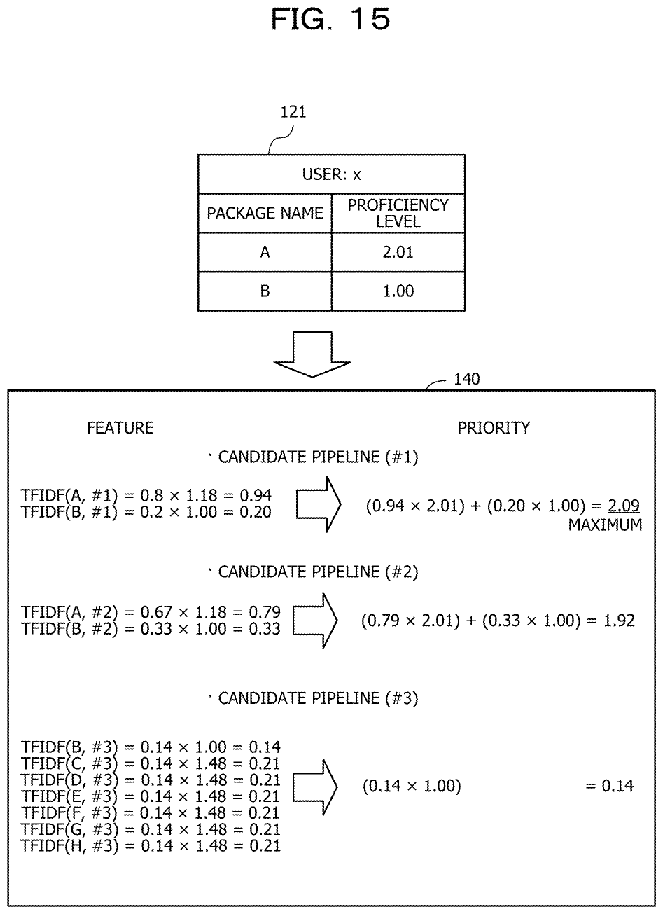

FIG. 15 is a diagram illustrating an example of a priority calculation. For example, it is assumed that a user “x” transmits a pipeline generation request. In this case, the priority calculation unit 140 refers to the proficiency level management table 121 of the user “x”. In the example illustrated in FIG. 15, a proficiency level of the user “x” for the package “A” is “2.01”. A proficiency level of the user “x” for the package “B” is “1.00”. Therefore, in calculation of a priority, the priority calculation unit 140 sets a weight “weight(A)=2.01” for the package “A” and sets a weight “weight(B)=1.00” for the package “B”.

In this case, a priority of the candidate pipeline 131 of “#1” is “(0.94×2.01)+(0.20×1.00)=2.09”. A priority of the candidate pipeline 132 of “#2” is “(0.79×2.01)+(0.33×1.00)=1.92”. A priority of the candidate pipeline 133 of “#3” is “(0.14×1.00)=0.14”.

The candidate pipeline 131 having the highest priority calculated in this manner is a candidate pipeline that is most easily edited by the user “x”. The packages “A” and “B” are used in both the candidate pipeline 131 of “#1” and the candidate pipeline 132 of “#2” in the example in FIG. 15, and the package “A” is used more in the candidate pipeline 131 of “#1”. It is considered that the candidate pipeline 131 including more packages having the high proficiency levels is more likely to catch knowledge and interest of the user. For example, it is easy for the user to start editing.

In a case where the proficiency level of the package “B” is much higher than the proficiency level of the package “A”, there is a possibility that the candidate pipeline 132 of “#2” is selected due to a difference between the features of the pipelines. Even in this case, the user may easily start the editing the candidate pipeline 132 with the package “B” as a starting point.

A pipeline to be presented to the user is determined based on the feature of the package in each candidate pipeline and the proficiency level of the user for each package. In a case where there is no significant difference between the proficiency levels with respect to the packages, a candidate pipeline having a larger feature for each package being used has a higher priority.

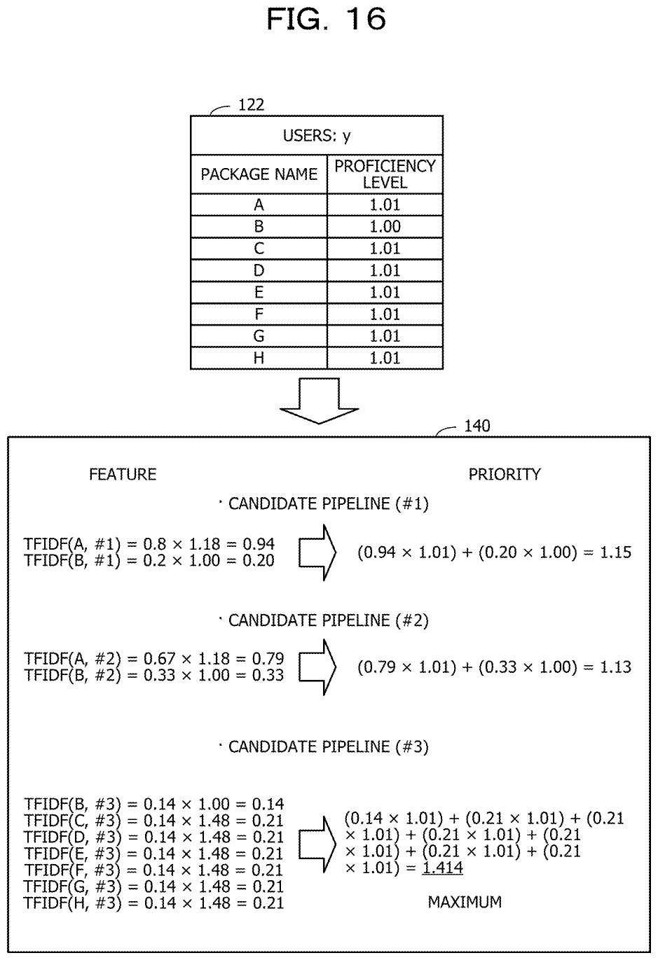

FIG. 16 is a diagram illustrating an example of a priority calculation in a case where there is no large difference between proficiency levels. For example, it is assumed that a user “y” transmits a pipeline generation request. In this case, the priority calculation unit 140 refers to the proficiency level management table 122 of the user “y”. In the example illustrated in FIG. 16, proficiency levels of the respective packages “A”, “C”, “D”, “E”, “F”, “G”, and “H” of the user “y” are all “1.01”. A proficiency level of the user “y” for the package “B” is “1.00”. Therefore, the priority calculation unit 140 sets a weight of the package “A” to “weight(A)=1.01” in calculation of a priority. Weights assigned to the packages “C”, “D”, “E”, “F”, “G”, and “H” are the same as the weight assigned to the package “A”. The priority calculation unit 140 sets a weight of the package “B” to “weight(B)=1.00”.

In this case, a priority of the candidate pipeline 131 of “#1” is “(0.94×1.01)+(0.20×1.00)=1.15”. A priority of the candidate pipeline 132 of “#2” is “(0.79×1.01)+(0.33×1.00)=1.13”. A priority of the candidate pipeline 133 of “#3” is “(0.14×1.01)+(0.21×1.01)+(0.21×1.01)+(0.21 ×1.01)+(0.21×1.01)+(0.21×1.01)+(0.21×1.01)=1.414”.

In a case where there is almost no difference between the proficiency levels of the packages, a priority of a candidate pipeline having a large sum of the features of the package being used becomes high, and the candidate pipeline is specified as a pipeline to be presented to the user. In the example in FIG. 16, a priority of the candidate pipeline 133 of “#3” is the highest, and the candidate pipeline 133 is presented to the user “y”.

In a case where there is no large difference in feature for each package used by the plurality of candidate pipelines 131 to 133, a candidate pipeline having a higher proficiency level for the package has a higher priority.

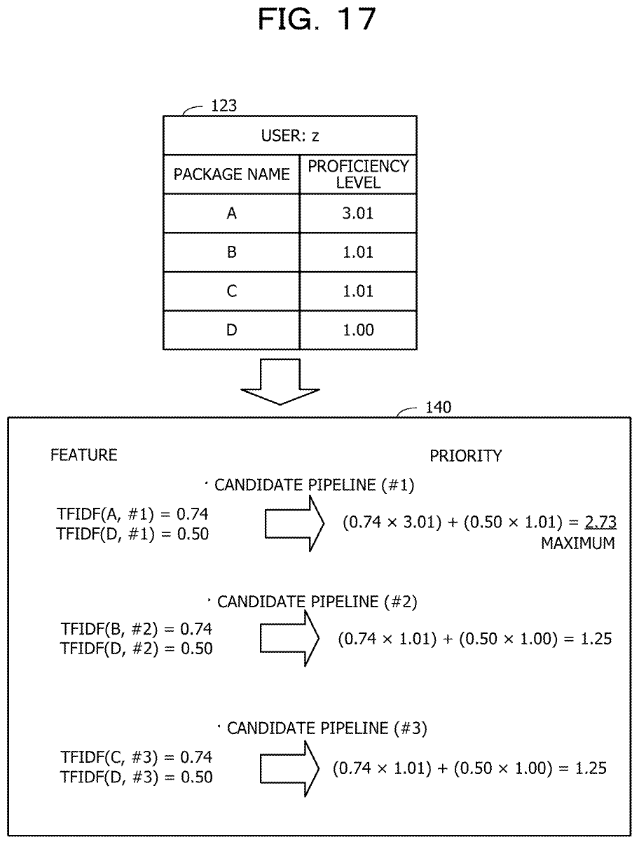

FIG. 17 is a diagram illustrating an example of a priority calculation in a case where there is no large difference between features of pipelines being used. In the example illustrated in FIG. 17, the packages “A” and “D” are used in the candidate pipeline 131 of “#1”. A feature of the package “A” is “0.74”, and a feature of the package “D” is “0.50”. The packages “B” and “D” are used in the candidate pipeline 132 of “#2”. A feature of the package “B” is “0.74”, and the feature of the package “D” is “0.50”. The packages “C” and “D” are used in the candidate pipeline 133 of “#3”. A feature of the package “C” is “0.74”, and the feature of the package “D” is “0.50”. In this manner, in each of the candidate pipelines 131 to 133, there is no difference between the features of the packages being used.

In this example, it is assumed that a user “z” transmits a pipeline generation request. In this case, the priority calculation unit 140 refers to the proficiency level management table 123 of the user “z”. In the example illustrated in FIG. 17, a proficiency level of the user “z” for the package “A” is “3.01”. A proficiency level of the user “z” for the package “B” is “1.01”. A proficiency level of the user “z” for the package “C” is “1.01”. A proficiency level of the user “z” for the package “D” is “1.00”.

The priority calculation unit 140 sets a weight of the package “A” to “weight(A)=3.01”. The priority calculation unit 140 sets a weight of the package “B” to “weight(B)=1.01”. The priority calculation unit 140 sets a weight of the package “C” to “weight(C)=1.01”. The priority calculation unit 140 sets a weight of the package “D” to “weight(D)=1.00”.

In this case, a priority of the candidate pipeline 131 of “#1” is “(0.74×3.01)+(0.50×1.01)=2.73”. A priority of the candidate pipeline 132 of “#2” is “(0.74×1.01)+(0.50×1.00)=1.25”. A priority of the candidate pipeline 133 of “#3” is “(0.74×1.01)+(0.50×1.00)=1.25”.

In this manner, in a case where there is no difference between the features of the packages used by the respective candidate pipelines, the priority of the candidate pipeline 131 using a package having a high proficiency level is the highest. The candidate pipeline 131 is presented to the user as the pipeline 161 as an editing target.

After the candidate pipeline having the highest priority is presented to the user as the pipeline 161 as an editing target, accuracy of each of the candidate pipelines 131 to 133 is evaluated, and a candidate pipeline having the highest accuracy is also presented to the user. Hereinafter, the process of selecting a pipeline to be presented to a user will be described in detail with reference to FIG. 18.

FIG. 18 is a flowchart illustrating an example of a procedure of a presentation pipeline selection process. Hereinafter, the processes illustrated in FIG. 18 will be described in order of operation numbers.
[operation S161] For each candidate pipeline, the priority calculation unit 140 acquires a name of a use package.
[operation S162] For each candidate pipeline, the priority calculation unit 140 acquires a feature of the package used in the candidate pipeline. For example, the priority calculation unit 140 calculates the feature by TF-IDF.
[operation S163] The priority calculation unit 140 determines whether or not a priority is calculated for all the candidate pipelines. In a case where there is a candidate pipeline for which a priority is not calculated, the priority calculation unit 140 shifts the process to operation S164. When the calculation of the priority is completed for all the candidate pipelines, the priority calculation unit 140 shifts the process to operation S166.
[operation S164] The priority calculation unit 140 acquires one candidate pipeline for which a priority is not calculated.
[operation S165] The priority calculation unit 140 calculates a priority of the acquired candidate pipeline. The priority is, for example, “a total sum of (feature×proficiency level) of package”. After that, the priority calculation unit 140 shifts the process to operation S163.
[operation S166] The pipeline presentation unit 160 presents a candidate pipeline having the highest priority to a user as a pipeline of an editing target.
[operation S167] The evaluation unit 150 executes all the candidate pipelines, and obtains accuracy of a model generated by using the candidate pipeline.
[operation S168] The evaluation unit 150 determines whether or not the accuracy may be acquired for one or more candidate pipelines. In a case where a candidate pipeline for which the accuracy may be acquired exists, the evaluation unit 150 shifts the process to operation S169. In a case where the accuracy may not be acquired for all the candidate pipelines, the evaluation unit 150 ends the presentation pipeline selection process.
[operation S169] The evaluation unit 150 determines whether or not the candidate pipeline having the highest accuracy is presented to the user.

In a case where the candidate pipeline is presented, the evaluation unit 150 ends the presentation pipeline selection process. When the candidate pipeline is not presented, the evaluation unit 150 shifts the process to operation S170.
[operation S170] The pipeline presentation unit 160 presents the candidate pipeline having the highest accuracy to the user as a pipeline to be used as a reference for editing.

In this manner, the candidate pipeline having the highest priority calculated using a proficiency level of the user is presented to the user first. After that, when the candidate pipeline having the highest accuracy is found by executing all the candidate pipelines, the candidate pipeline is also presented to the user.

As described above, with the machine learning support system 100 according to the second embodiment, a pipeline that is easily edited by a user is presented as an editing target. Therefore, the user may efficiently edit the pipeline. Further, since the editing target pipeline is presented without waiting for the completion of the calculation of the accuracy of all the candidate pipelines, a time until a start of the editing work is reduced.

In the calculation of the proficiency level of the package of the user, a difference in accuracy of the package before and after the editing by the user is used. Thus, the proficiency level of the user is correctly calculated. Since the proficiency level is accurate, accuracy of the calculation of the priority using the proficiency level is improved. As a result, it is possible to correctly present the pipeline that is easily edited by the user.

### Other Embodiments

Although, in the second embodiment, the machine learning support system 100 calculates the accuracy of the candidate pipeline after calculating the priority of all the generated candidate pipelines, the calculation of the priority of the candidate pipeline and the calculation of the accuracy of the candidate pipeline may be executed in parallel. Thus, it is possible to reduce the time until the pipeline with high accuracy is presented.

Although the candidate pipeline is evaluated by the accuracy of the generated model in the second embodiment, the evaluation index of performance of the model includes an index such as a relevance ratio or a recall rate, in addition to the accuracy (correct answer rate). As the evaluation of the candidate pipeline, a performance index other than the accuracy of the generated model may be used, or a plurality of indices may be combined.

Hereinbefore, the embodiments are exemplified, the configuration of each unit described in the embodiment may be replaced with another unit having the same function. Other arbitrary components or steps may be added. Arbitrary two or more configurations of the embodiments described above may be combined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a machine learning support program causing a computer to execute a process, the process comprising:
receiving, by a machine learning support system, an instruction to generate a machine learning model from a plurality of candidate programs;
specifying, for each of the plurality of candidate programs generated using a program component included in any of a plurality of program component sets, a first proficiency level of a user for a first program component set which includes a first program component used in the candidate program,
the first proficiency level is based on proficiency level information which indicates a proficiency level of the user related to use of each of the plurality of program component sets and is determined based on a use record of the plurality of program component sets in an editing process of the candidate program by the user and a change in performance of the candidate program by the editing process; and
determining, for each of the plurality of candidate programs, a priority to present the candidate program to the user, based on the specified first proficiency level.

2. The non-transitory computer-readable recording medium according to claim 1, the process further comprising:
outputting at least one of the plurality of candidate programs as a first program which is a generation result according to the program generation request, based on the priority of each of the plurality of candidate programs.

3. The non-transitory computer-readable recording medium according to claim 2, the process further comprising:
generating a second program when the first program is edited by the user;
specifying a second program component set which includes a second program component added to the second program; and
updating a second proficiency level of the user for the specified second program component set.

4. The non-transitory computer-readable recording medium according to claim 3, the process further comprising:
obtaining a difference between a first evaluation value which indicates an evaluation result of performance of a first model generated by the first program and a second evaluation value which indicates an evaluation result of performance of a second model generated by the second program,
wherein, in the updating of the second proficiency level of the user, an increase amount of the second proficiency level of the user for the second program component set is obtained based on the obtained difference, and
wherein the obtained increase amount is added to the second proficiency level of the user for the second program component set in the proficiency level information.

5. The non-transitory computer-readable recording medium according to claim 4,
wherein, in the updating of the second proficiency level of the user, the increase amount of the second proficiency level of the user for the second program component set is obtained based on the obtained difference and a number of second program components added to the second program and included in the second program component set.

6. The non-transitory computer-readable recording medium according to claim 1, the process further comprising:
obtaining a feature which indicates an importance degree of the first program component set in a first candidate program as a determination target, and
wherein, in the determining of the priority of each of the plurality of candidate programs, a first priority of the first candidate program is determined based on the obtained feature and the first proficiency level of the user for the first program component set.

7. The non-transitory computer-readable recording medium according to claim 1, the process further comprising:
receiving, with the machine learning support system, task setting information and a dataset; and
automatically generating with automated machine learning (AutoML) the plurality of candidate pipelines.

8. The non-transitory computer-readable recording medium according to claim 1, wherein
the program component is any one of a function, a class, and a variable, and
the program component sets are one of a library and a package.

9. The non-transitory computer-readable recording medium according to claim 6, wherein the feature is a term frequency-inverse document frequency (TF-IDF).

10. The non-transitory computer-readable recording medium according to claim 1, wherein in a case where there is no difference in the proficiency level of the program component set including the program components used in the plurality of candidate programs, a candidate program using a highest number of program components included in a program component set is assigned a highest priority.

11. A machine learning support method comprising:
receiving, by a machine learning support system, an instruction to generate a machine learning model from a plurality of candidate programs;
specifying, for each of the plurality of candidate programs generated using a program component included in any of a plurality of program component sets, a first proficiency level of a user for a first program component set which includes a first program component used in the candidate program,
the first proficiency level is based on proficiency level information which indicates a proficiency level of the user related to use of each of the plurality of program component sets and is determined based on a use record of the plurality of program component sets in an editing process of the candidate program by the user and a change in performance of the candidate program by the editing process; and
determining, for each of the plurality of candidate programs, a priority to present the candidate program to the user, based on the specified first proficiency level.

12. The machine learning support method according to claim 11, further comprising:
outputting at least one of the plurality of candidate programs as a first program which is a generation result according to the program generation request, based on the priority of each of the plurality of candidate programs.

13. The machine learning support method according to claim 12, further comprising:
generating a second program when the first program is edited by the user;
specifying a second program component set which includes a second program component added to the second program; and
updating a second proficiency level of the user for the specified second program component set.

14. The machine learning support method according to claim 13, further comprising:
obtaining a difference between a first evaluation value which indicates an evaluation result of performance of a first model generated by the first program and a second evaluation value which indicates an evaluation result of performance of a second model generated by the second program,
wherein, in the updating of the second proficiency level of the user, an increase amount of the second proficiency level of the user for the second program component set is obtained based on the obtained difference, and
wherein the obtained increase amount is added to the second proficiency level of the user for the second program component set in the proficiency level information.

15. The machine learning support method according to claim 14,
wherein, in the updating of the second proficiency level of the user, the increase amount of the second proficiency level of the user for the second program component set is obtained based on the obtained difference and a number of second program components added to the second program and included in the second program component set.

16. The machine learning support method according to claim 11, further comprising:
obtaining a feature which indicates an importance degree of the first program component set in a first candidate program as a determination target,
wherein, in the determining of the priority of each of the plurality of candidate programs, a first priority of the first candidate program is determined based on the obtained feature and the first proficiency level of the user for the first program component set.

17. An information processing apparatus comprising:
a memory; and
a processor coupled to the memory and configured to:
receive an instruction to generate a machine learning model from a plurality of candidate programs;
specify, for each of the plurality of candidate programs generated using a program component included in any of a plurality of program component sets, a first proficiency level of a user for a first program component set which includes a first program component used in the candidate program,
the first proficiency level is based on proficiency level information which indicates a proficiency level of the user related to use of each of the plurality of program component sets and is determined based on a use record of the plurality of program component sets in an editing process of the candidate program by the user and a change in performance of the candidate program by the editing process; and
determine, for each of the plurality of candidate programs, a priority to present the candidate program to the user, based on the specified first proficiency level.
